(19) United States
(12) Patent Application Publication
(10) Pub. No.: US 2015/0102518 A1
(43) Pub. Date: Apr. 16, 2015

(54) APPARATUS AND METHOD FOR HIGH THROUGHPUT EXTRUDATE PREPARATION

(71) Applicant: UOP LLC, Des Plaines, IL (US)

(72) Inventors: Guanghui Zhu, Arlington Heights, IL (US); Ornulv Vistad, Oslo (NO); Larry P. Ranes, Round Lake, IL (US); Arne Karlsson, Oslo (NO)

(73) Assignee: UOP LLC, Des Plaines, IL (US)

(21) Appl. No.: 14/054,048

(22) Filed: Oct. 15, 2013

(51) Int. Cl. B29B 11/10

(52) U.S. Cl. CPC B29B 11/10; B29L 2031/757
USPC 264/176.1; 425/382 R

(57) ABSTRACT

The invention relates to a high throughput apparatus and method for preparing extrudate. The apparatus and method allow the production of small quantities (e.g., less than about 50 g) of extrudates quickly and easily. A multi-chamber setup for peptized binder addition, mixing and extrusion, is combined with high speed impeller to provide a process to prepare small quantity extrudates in high throughput fashion.

### BACKGROUND OF THE INVENTION

Extrusion is a commonly used method to prepare adsorbents and catalysts for refining and petrochemical processes. In this method, extrusion dough is prepared by mixing binder(s), active component(s), water and digesting reagent together. The dough is then pushed through a die plate to form extrudates. Mixing is one of the key steps in the extrusion process. For small quantity extrudate preparation (e.g., less than about 20 g), especially for new material studies when the quantity is very limited, a mixing tool which can handle small amount of materials is needed. Also, for new material screening studies where a variety of materials are to be evaluated, high throughput extrudate preparation is needed to improve the productivity and match the throughput of other tools, such as calcination, metal impregnation and testing/screening.

There are no commercial mixers and related setups available for small size high throughput extrudate preparation. All the mixers for high viscosity materials, such as double planetary mixers, acoustic sound mixers, and centrifuge mixers, are either for larger quantity mixing, or for materials with a lower viscosity than extrusion dough. Even for those having the potential for small size extrusion dough mixing, the setup is not suitable for high throughput extrusion because only one sample can be prepared at a time, and the dough must be moved from the mixing chamber to the extrusion chamber, which is extremely time consuming.

Therefore, there is a need for apparatus and methods to make small quantities of extrudate having high throughput capability.

### SUMMARY OF THE INVENTION

One aspect of the invention is a high throughput apparatus for preparing extrudate. The apparatus includes a block having a plurality of chambers, the chambers open on both ends. There is a removable top plate covering the top end of the chambers, the top plate having a plurality of openings providing access to each of the chambers; and a removable solid bottom plate covering the bottom end of the chambers. There is an impeller movable into the openings in the top plate; and a removable die plate having a plurality of die openings aligned with each of the chambers.

Another aspect of the invention is a method of making extrudates. The method includes introducing extrudate components into a mixing apparatus, the mixing apparatus comprising: a block having a plurality of chambers, the chambers open on both ends; and a removable solid bottom plate covering the bottom end of the chambers. The extrudate components are mixed in the chambers with an impeller. The bottom plate is replaced with a removable die plate having at least one die opening aligned with each of the chambers, and the mixed extrudate components are extruded through the die plate.

### BRIEF DESCRIPTION OF THE DRAWINGS

FIG. 1 illustrates one embodiment of the apparatus of the present invention.

FIG. 2 illustrates one embodiment of the block with the collection vessels.

FIG. 3 illustrates one embodiment of the dosing plate.

FIG. 4 illustrates one embodiment of the block with dosing plate.

FIG. 5 illustrates one embodiment of the block.

FIG. 6 illustrates another embodiment of the block.

### DETAILED DESCRIPTION OF THE INVENTION

The invention relates to a high throughput apparatus and method for preparing extrudates. The apparatus and method allow the production of small quantities (e.g., less than about 50 g, or less than about 40 g, or less than about 30 g, or less than about 25 g, or less than about 20 g, or less than about 15 g, or less than about 12 g, or less than about 10 g, or less than about 7 g, or less than about 5 g, or less than about 3 g, or less than about 1 g) of extrudate quickly and easily. A multi-chamber setup for peptized binder addition, mixing, and extrusion is combined with high speed mixing to provide a process to prepare small quantity extrudates in high throughput fashion. The apparatus reduces mixing time, and also improves mixing quality. The small size samples produced using the apparatus can be used in new material evaluations where the amount of the material is limited. They can also be used to make a large number of samples for screening evaluations in a short amount of time.

The extrusion dough typically contains solid binder(s) and/or active components, water, and digesting reagent, such as acid. There are two typical methods to prepare the extrusion dough. In the first method, the digesting solution is pre-mixed with part/all of the binder(s) to form a gel, which is called peptization. The gel is then added to the mixture of remaining binder and/or active components to form the dough. In the second method, the digesting solution is mixed directly with all other components to form the dough.

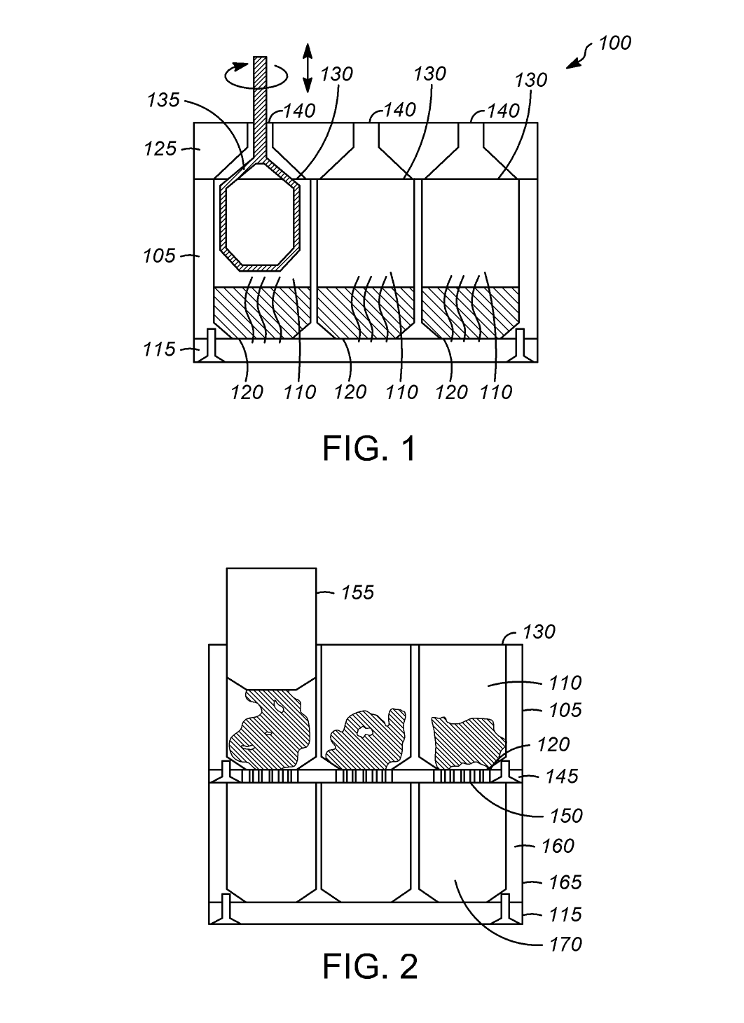

One embodiment of the apparatus 100 is illustrated in FIG. 1. There is a block 105 having a plurality of chambers 110. The chambers 110 are open on both ends. The block 105 can have an array of chambers 110, such as 3 rows of 4 chambers. The block 105 can be made of stainless steel or other materials resistant to friction and pressure damage.

There is a solid bottom plate 115 which can be removably attached to bottom end 120 of the chambers 110 in the block 105. The solid bottom plate can be made of stainless steel or other materials resistant to friction damage. There is a top plate 125 which can be removably attached to the top end 130 of the chambers 110. There are openings 140 in the top plate 125 which provide access to each of the chambers 110. The openings 140 can be slots in the top plate to allow the impeller 135 to be introduced into the chamber 110 for mixing. The shape of the opening should match the shape of the selected impeller. The top plate 125 can be made of stainless steel or other materials resistant to friction damage.

The top and bottom plates 125 and 115 are used to keep the materials inside the chambers during mixing.

An impeller 135 is inserted through the openings 140 in the top plate 125, and mixes the contents inside chambers 110. In addition to rotating, the impeller 135 can move vertically in the chamber (e.g., from the top to the bottom and back), if desired. The impeller 135 can have any suitable shape for mixing the material, e.g., an O-shape or a D-shape. The bottom of the impeller 135 can have a shape similar to the bottom of the chamber 110, and the top of the impeller can have a shape similar to the bottom of the top plate 125.

In some embodiments, the impeller 135 moves up and down in the chamber 110 to provide more thorough mixing. The movement can be controlled so that the impeller covers the chamber 110 without touching the top plate 125 or the bottom plate 115, if desired.

To remove the impeller 135 from the chamber 110, it is aligned with the opening 140 in the top plate 125 and withdrawn.

The impeller 135 typically operates at high speed (e.g., with rotation speeds greater than about 1500 rpm). High speed mixing not only reduces mixing time but also improves mixing quality.

There can be one or more impellers 135. In some embodiments, there are impellers 135 for each chamber 110, while in others there are impellers 135 for each row of chambers 110. With multiple impellers, they will typically be operating at the same time, e.g., using a multispindle head. Other arrangements are also possible. Increasing the number of impellers 135 and operating them at the same time reduces the cycle time required to mix the contents of the chambers (e.g., if there are 12 chambers and 1 impeller, and the mixing time is t, the mixing cycle time is 12 t, while if there are 3 impellers, the mixing cycle time is 4 t, and if there are 12 impellers, the mixing cycle time is t.

In order to provide better mixing, after initially mixing the contents of the chambers 110, the top plate 125 and the bottom plate 115 can be removed from the block 105. The block 105 can be turned upside down (so that bottom end 120 is facing up and the top end 130 is facing down). The bottom plate 115 can be attached to the top end 130 of the chamber 110, and the top plate 125 can be attached to the bottom end 120 of the chambers. The impeller 135 can then be inserted into the top plate 125 to mix the contents. Because the chambers have been inverted, the material which was at the bottom of the chamber is now at the top, allowing for more thorough mixing. This process can be repeated, if desired. After the contents of the chambers are mixed, the bottom plate 115 can be removed and replaced by a die plate 145, as illustrated in FIG. 2. The die plate 145 has a plurality of die openings 150 aligned with each of the chambers 110 to allow the dough to be extruded from the same chamber where it is mixed. With this feature, the prepared extrusion dough does not need to be transferred to other equipment for extrusion, reducing operation time and avoiding material loss during transfer.

There can be one or more die openings for each chamber. If there is more than one, the die openings can be the same size, or they can be different sizes. In addition, the die openings can be the same for all chambers, or they can be different in number or size or both.

In an alternate embodiment, the die plate can have a hole for each chamber. Individual dies with die openings can be placed in the holes; the individual dies can have die openings of different sizes and geometry. The individual dies can be quickly and easily changed as desired.

A piston 155 is inserted into the chamber 110 to force the mixed extrudate components through the die openings 150. There can be one or more pistons 155. If more than one piston is used, they can be operated at the same time, if desired. Increasing the number of pistons and operating them together reduces the extrusion cycle time, similar to the way increasing the number of impellers and operating them together reduces the mixing cycle time.

The piston 155 is typically substantially the same size as the chambers 110. By “substantially the same size,” we mean that the piston 155 fills the chambers 110 so that most of the extrudate is forced out of the chambers 110 through the die openings 150, but it can slide in the chambers without binding.

Because the piston 155 is substantially the same size as the chambers 110, at least the surface of the piston 155 is a different material from the surface of the chambers 110 so that the piston 155 does not seize in the chambers 110. In some embodiments, the piston 155 and the block 105 are made of different materials. In other embodiments, they are made of the same material, but the surface of one or both is treated to get different hardness and/or a different surface composition.

The extruded material can be collected in collection vessels 160. In one embodiment, the collection vessels 160 comprise a vessel block 165 attached to the removable bottom plate 115. The vessel block 165 has chambers 170 aligned with the die openings 150 and chambers 110 of the block 105. When the piston 155 extrudes the mixed material through the openings 150 in the die plate 145, the extrudate is collected in the collection vessels 160. In this arrangement, the collected extrudate can be sent directly for drying without changing vessels.

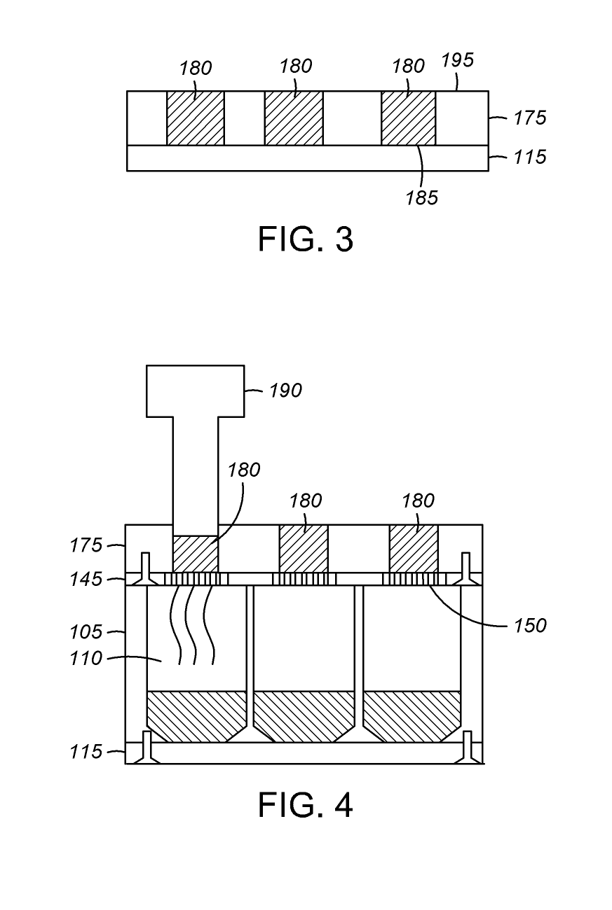

When using the first method to prepare extrusion dough, it is faster to load equal amounts of peptized binder to the mixing chamber using a dosing plate 175. The dosing plate 175, as shown in FIG. 3, can be used to ensure that the samples have the same volume. The dosing plate 175 has chambers 180 which align with the chambers 110 of the block 105. The chambers 180 of the dosing plate 175 are open on both ends. The base plate 115 is attached to the bottom end 185 the dosing plate 175. Peptized binder is introduced into the chambers 180 of the dosing plate 175. Any excess material is removed so that the surface of the material is even with the top end 195 of the dosing plate 175. The base plate 115 can then be removed, the dosing plate 175 turned upside down, and the base plate 115 attached to the top end 195 of the dosing plate 175. Additional material can be used to fill the chambers 180 as needed.

The base plate 115 is then removed (whether after compacting from one side or both sides). The die plate 145 is attached to the dosing plate 175 and the block 105. The rod 190 is pushed through the chamber 180 forcing the material though the die openings 150 and into the chambers 110 of the block 105. The material can then be mixed using the procedure described above.

Alternatively, the dosing plate can provide samples with variable volume. In one embodiment of this arrangement, the dosing plate could have a variable thickness. For example, the thickness can vary from one edge to the opposite edge or from one corner to the opposite corner. Another embodiment of variable volume dosing would be to have the chambers of different diameters. However, this would require rods of different sizes as well, complicating the process.

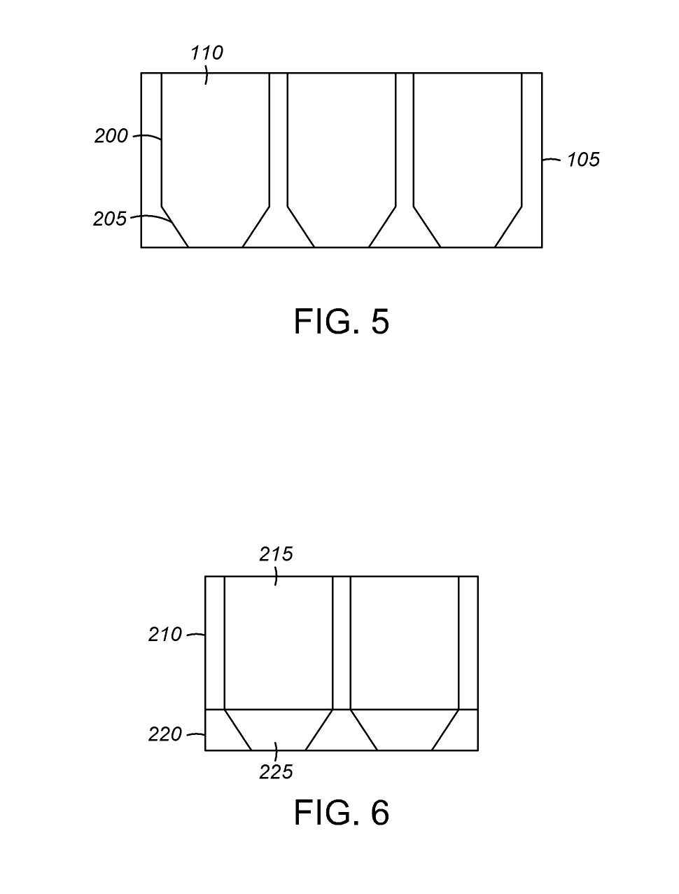

The chambers 110 of the block 105 can be any shape desired. In some embodiments, such as shown in FIG. 5, the chambers 110 have a cylindrical portion 200 and a conical portion 205. The piston 155 can have a similar shape in order to remove as much of the mixed material as possible. Alternatively, as shown in FIG. 6, there can a block 210 having cylindrical chambers 215, and a block 220 having conical chambers 225. In this case, the mixing could be done in the block 210 only, while the extrusion through the die plate 145 could be done with both the block 210 and the block 220 in order to remove as much of the material as possible. Using a cylindrical chamber 215 in the block 210 allows mixing from the top and bottom more easily. It would also help to reduce the amount of materials not being mixed.

The various plates and blocks can have aligning pins and corresponding holes to assist in properly aligning the plates, if desired.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A high throughput apparatus for preparing extrudate comprising:
a block having a plurality of chambers, the chambers open on both ends;
a removable top plate covering the top end of the chambers, the top plate having a plurality of openings providing access to each of the chambers;
a removable solid bottom plate covering the bottom end of the chambers;
an impeller movable into the openings in the top plate; and
a removable die plate having a plurality of die openings aligned with each of the chambers.

2. The apparatus of claim 1 further comprising a plurality of collection vessels below the die plate, the collection vessels aligned with the die openings and the chambers.

3. The apparatus of claim 1 further comprising a piston movable in the chambers.

4. The apparatus of claim 3 wherein the piston is substantially the same size as the chambers.

5. The apparatus of claim 3 wherein a surface of the piston is made of a different material from a material of a surface of the chambers.

6. The apparatus of claim 1 further comprising a dosing plate having a plurality of chambers aligned with the chambers of the block.

7. The apparatus of claim 1 wherein the chambers in the block are cylindrical.

8. The apparatus of claim 7 further comprising a second block having plurality of conical chambers aligned with the chambers of the block.

9. The apparatus of claim 1 wherein the chambers of the block have a cylindrical portion and a conical portion.

10. A method of making extrudate comprising:
introducing extrudate components into a mixing apparatus, the mixing apparatus comprising: a block having a plurality of chambers, the chambers open on both ends; and a removable solid bottom plate covering the bottom end of the chambers;
mixing the extrudate components in the chambers with an impeller;
replacing the bottom plate with a removable die plate having at least one die opening aligned with each of the chambers;
extruding the mixed extrudate components through the die plate.

11. The method of claim 10 further comprising;
collecting the extruded extrudate in a plurality of collection vessels positioned under the die plate, the collection vessels aligned with the at least one die opening and the chambers.

12. The method of claim 10 further comprising:
placing a removable top plate on the block before mixing the extrudate components, the top plate covering the top end of the chambers, the top plate having a plurality of openings providing access to each of the chambers; and
introducing the impeller into one of the chambers by placing the impeller through one of the openings in the top plate.

13. The method of claim 10 wherein introducing the extrudate components into the mixing apparatus comprises:
providing a dosing plate having a plurality of chambers aligned with the chambers of the block;
filling the chambers of the dosing plate with the extrudate components; and
pushing the extrudate components from the chambers in the dosing plate into the chambers of the block.

14. The method of claim 13 wherein filling the chambers of the dosing plate with the extrudate components comprises:
placing a solid bottom plate on a first side of the dosing plate;
introducing the extrudate components into the chambers of the dosing plate;
compacting the extrudate components in the chambers of the dosing plate;
removing the bottom plate from the first side of the dosing plate; and
placing the dosing plate on the block before pushing the extrudate components from the chambers of the dosing plate.

15. The method of claim 14 further comprising;
placing the bottom plate on the opposite side of the dosing plate after removing the bottom plate from the first side of the dosing plate and before placing the dosing plate on the block;
compacting the extrudate components in the chambers in the dosing plate; and
adding extrudate components to the chambers in the dosing plate.

16. The method of claim 13 further comprising:
placing the die plate on the dosing plate after filling the chambers of the dosing plate and before pushing the extrudate components from the chambers in the dosing plate.

17. The method of claim 10 wherein the chambers are cylindrical, and further comprising:
placing a second block adjacent to the bottom end of the block after mixing the extrudate components and before attaching the die plate, the second block having plurality of conical chambers aligned with the chambers of the block.

18. The method of claim 10 wherein extruding the mixed extrudate components through the die plate comprises:
pushing a piston into the chambers to extrude the mixed extrudate components.

19. The method of claim 10 wherein mixing the extrudate components in the chambers with the impeller comprises:
introducing the impeller into the chambers;
moving the impeller from the top of the chamber to the bottom of the chamber and back to the top of the chamber.

20. The method of claim 10 wherein mixing the extrudate components comprises:
introducing the impeller into the top end of the chambers to mix the components;
removing the bottom plate from the bottom end of the block and placing the bottom plate on the top end;
introducing the impeller into the bottom end of the chamber; and
mixing the extrudate components.
